(19) United States
(12) Patent Application Publication
(10) Pub. No.: US 2017/0025883 A1
(43) Pub. Date: Jan. 26, 2017

(54) MULTI-CHARGEABLE (AC/DC/SOLAR/WIRELESS, ETC) AND MULTI-FUNCTIONAL (SECURES, ORGANIZES, CHARGES, STORES, DOCKS, ETC.) ENERGY STORAGE CASE FOR INTELLIGENT, AUTOMATIC, AND SIMULTANEOSLY CHARGING OF MULTIPLE ELECTRONICS DEVICES.

(71) Applicant: KEVIN SCOTT BALL, MONROE, MI (US)

(72) Inventor: KEVIN SCOTT BALL, MONROE, MI (US)

(21) Appl. No.: 15/011,109

(22) Filed: Jan. 29, 2016

Related U.S. Application Data
(60) Provisional application No. 62/110,381, filed on Jan. 30, 2015.

(51) Int. Cl. H02J 7/02; H02J 50/40; H02J 50/12; H02J 7/35; H02J 7/00

(52) U.S. Cl. CPC H02J 7/025; H02J 7/35; H02J 7/0027; H02J 7/0044; H02J 50/12; H02J 50/40

(57) ABSTRACT

A multi-chargeable and multi-functional energy storage case for intelligent, automatic, and simultaneous wireless charging of multiple electronic devices. The energy storage device utilizes the best in battery technology to maximize the usefulness of electronic devices and it can be charged in a variety of ways. It can be charged via traditional alternating current (AC), via direct current (DC) as from a cigarette lighter receptacle in an automobile, from attached solar panels, or wirelessly via inductive charging spots that are beginning to appear in coffee shops and restaurants throughout the country. In addition, the case is multi-functional. The device is capable of organizing, storing, docking, wirelessly charging multiple electronic devices, and is equipped with security sensors for the security of electronic devices. The onboard intelligent power management system automatically identifies and delivers optimal power load to multiple electronic devices simultaneously according to industry standards.

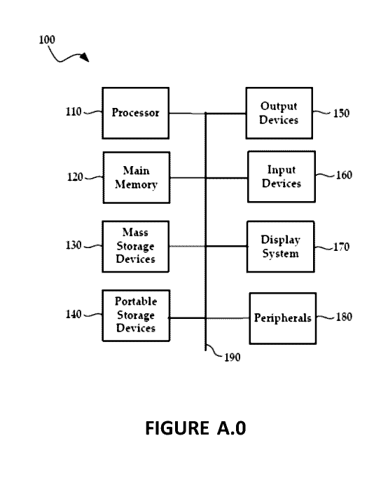

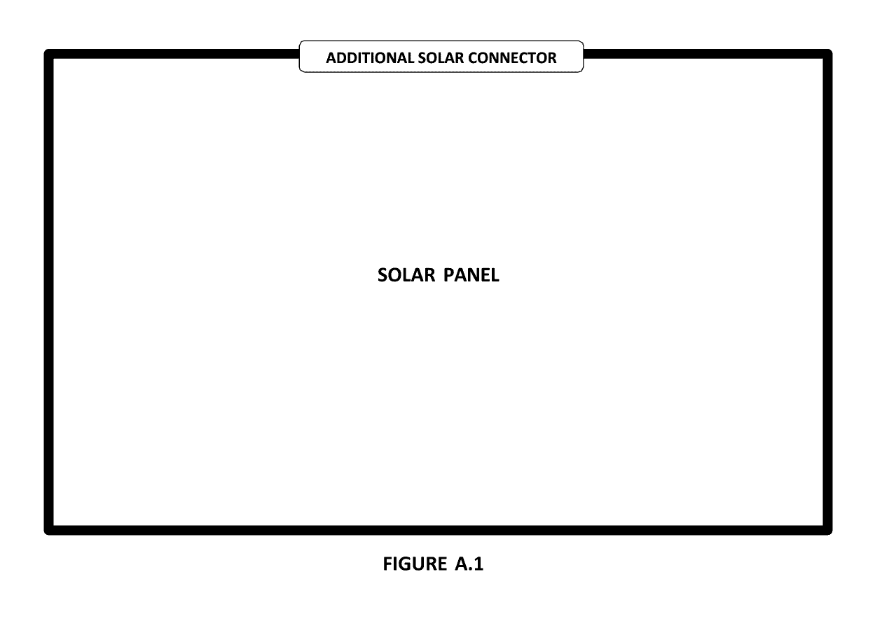

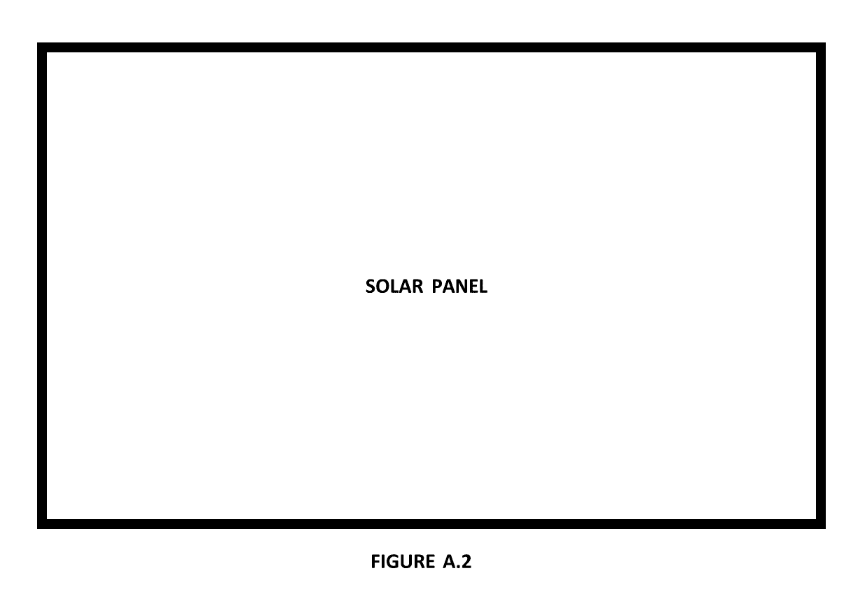

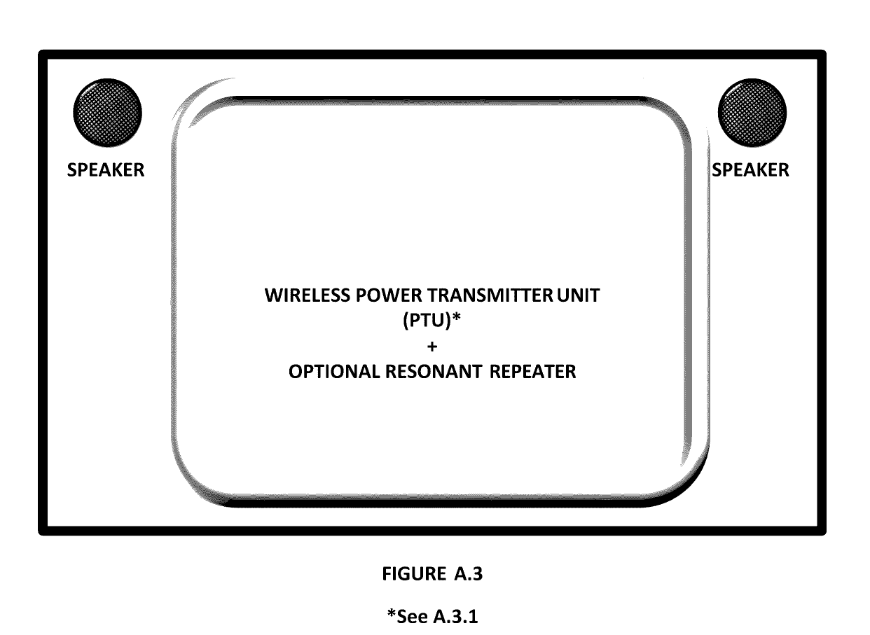

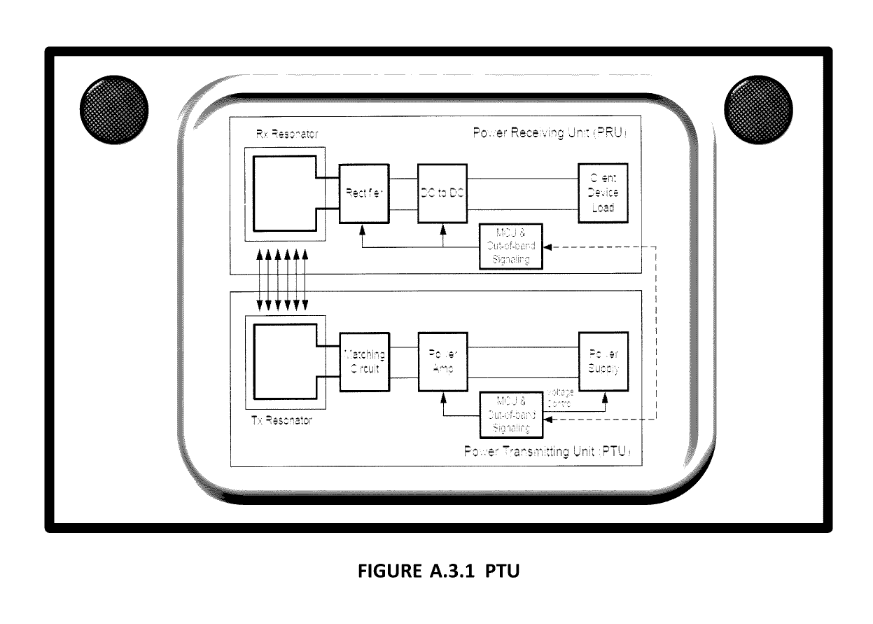

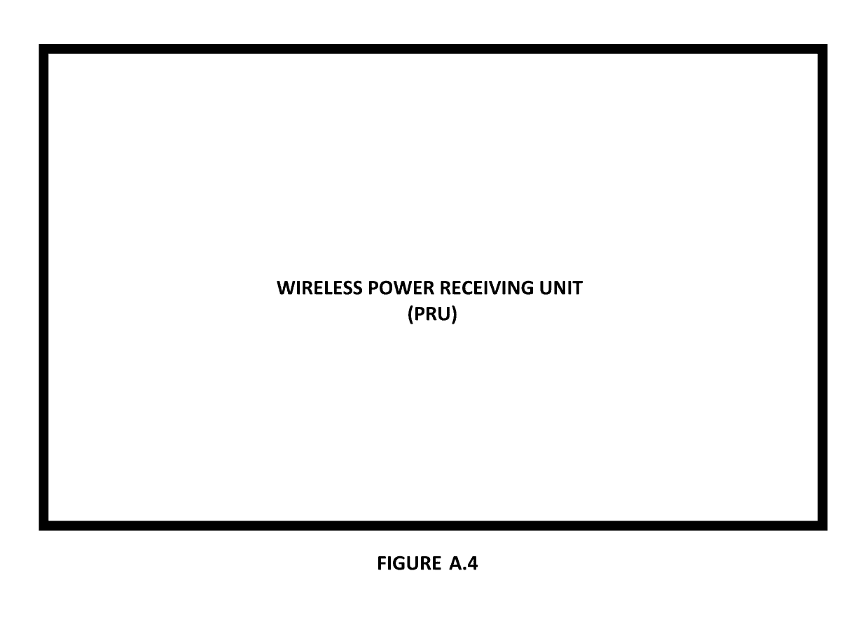

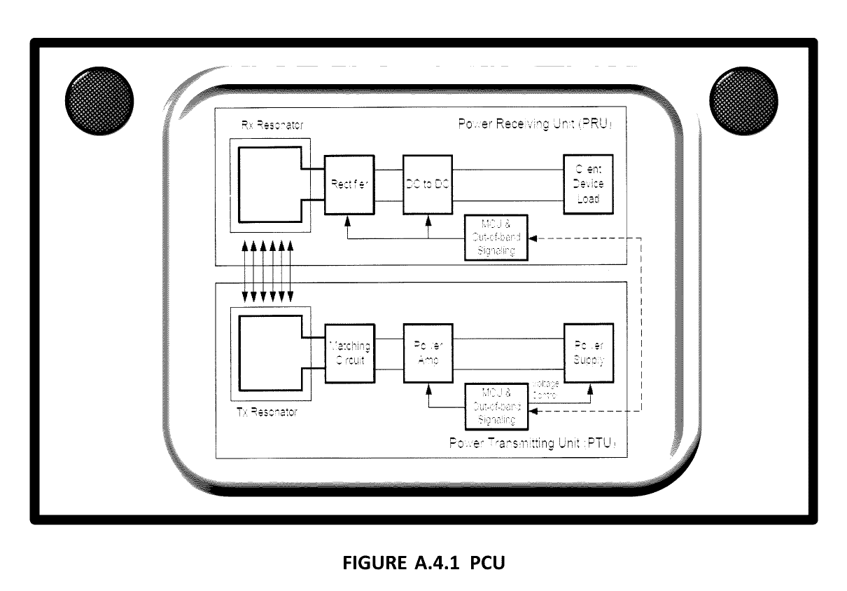

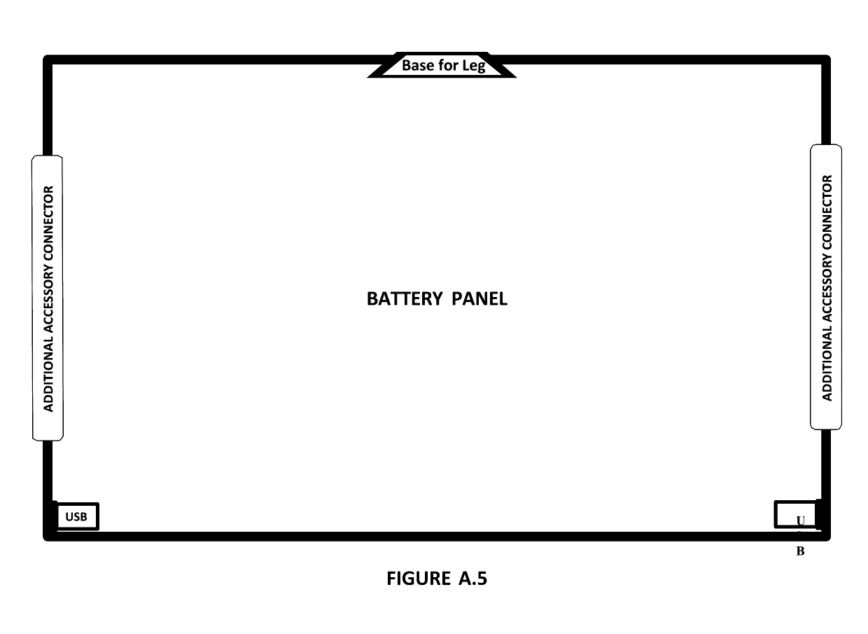

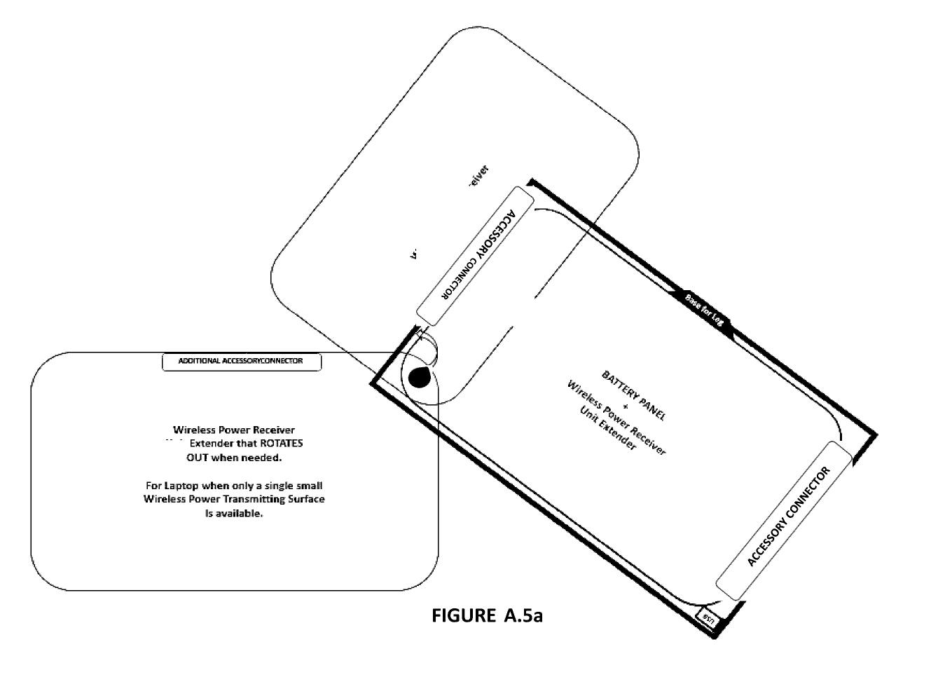

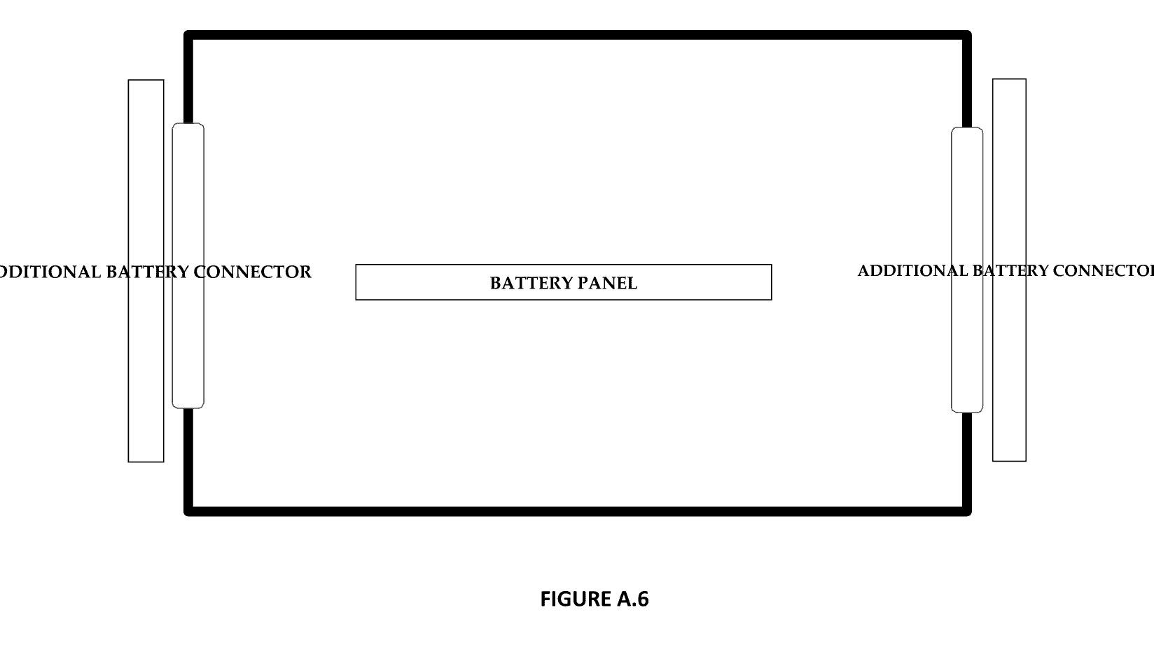

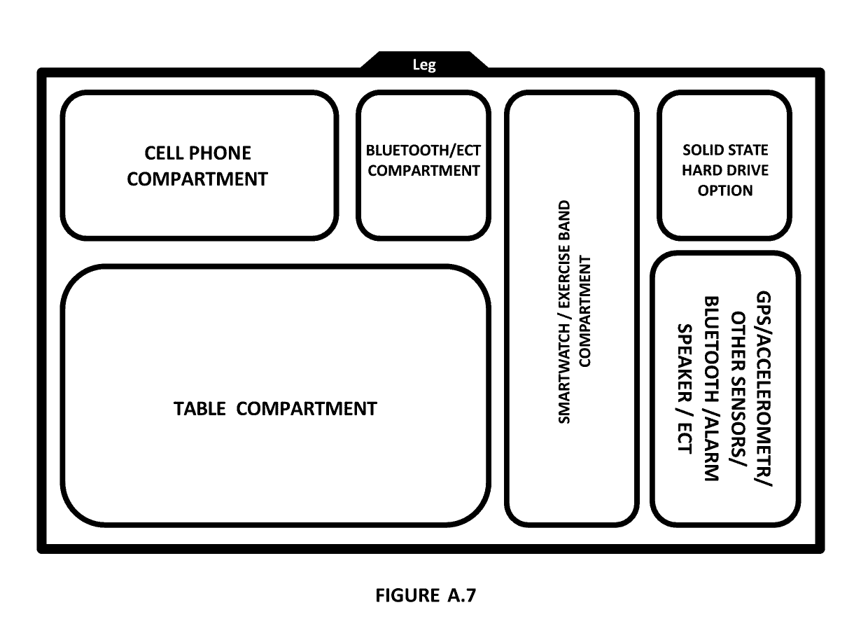

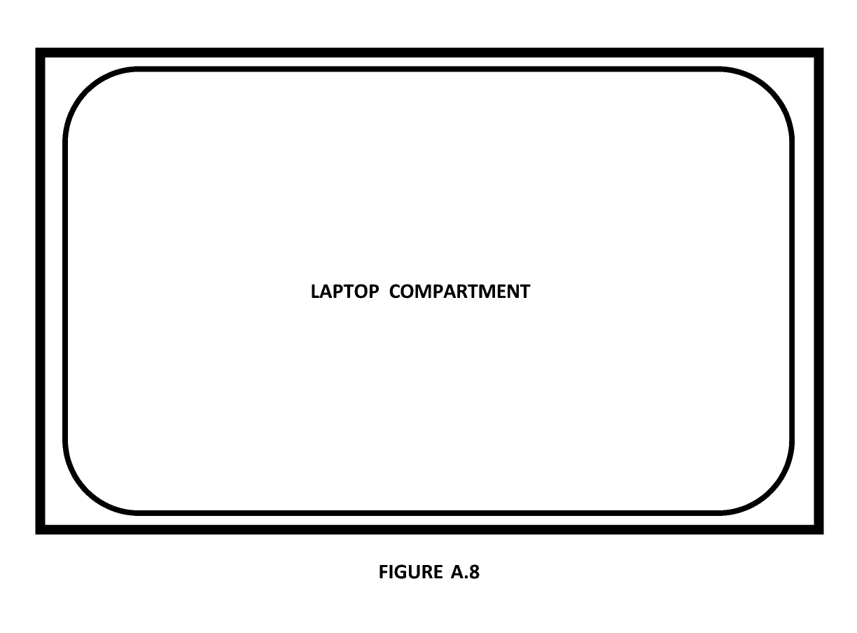

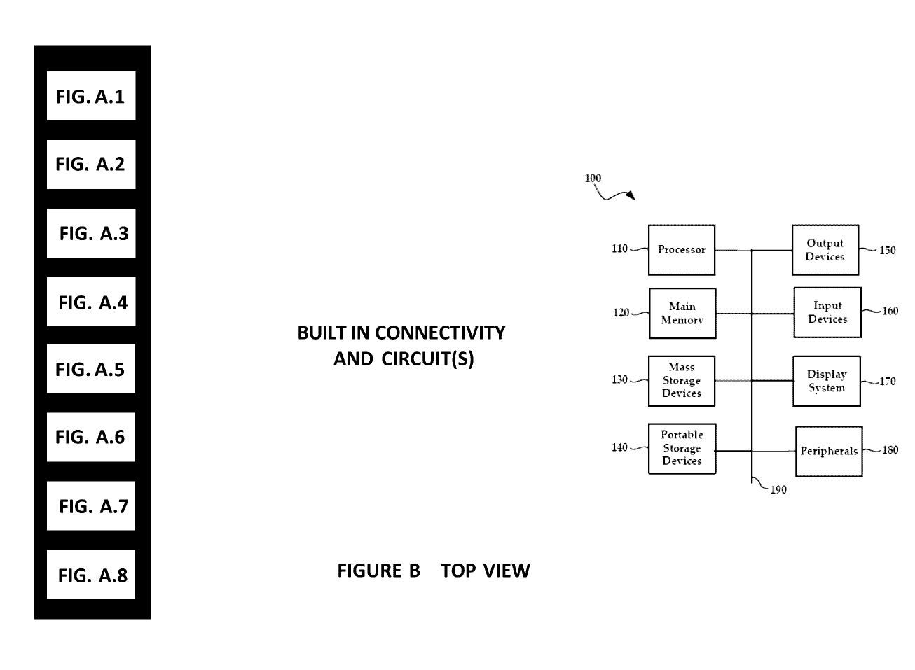

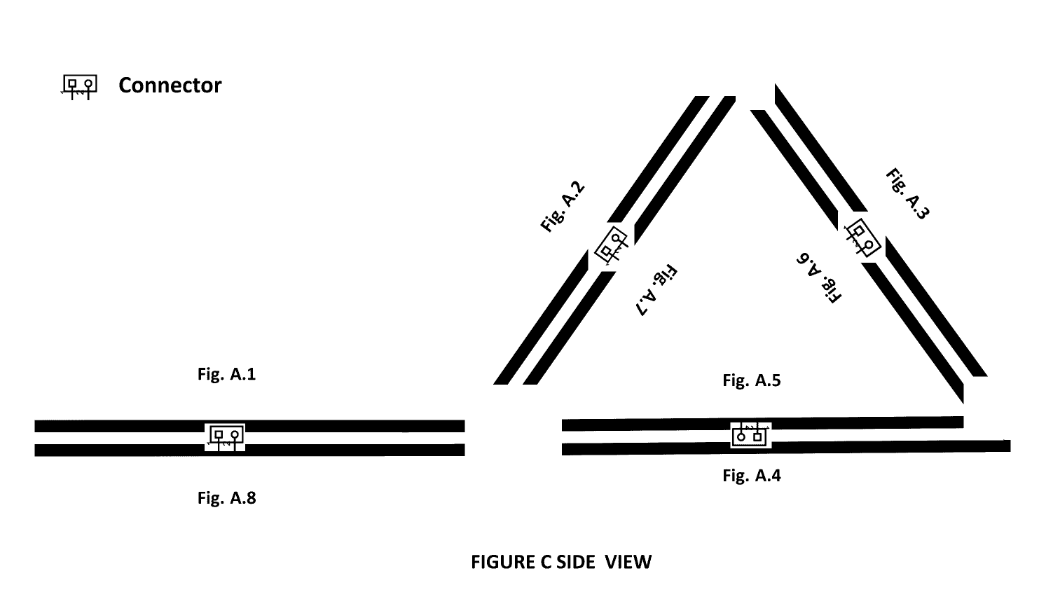

### CROSS-REFERENCE TO RELATED APPLICATIONS

*See Provisional Application No. 62/110,381

### STATEMENT REGARDING FEDERALLY SPONSORED RESEARCH

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY INVENTOR OR JOINT INVENTOR

Not Applicable

### BACKGROUND OF THE INVENTION

(1) Field of the Invention

The present technology relates generally to a device for storing and charging electronic devices, and more particularly, but not by way of limitation, to a rechargeable battery sleeve that stores and simultaneously charges multiple personal electronic devices such as cellular telephones, tablets, and e-readers, smart watches, Bluetooth headsets, etc. as well as itself, automatically.

One of the key goals of the electronics industry is to extend the runtime of electronic devices. The proposed present technology is an energy harvesting multi-purpose protective battery sleeve that can acquire energy from multiple sources while at the same time charging multiple devices simultaneously so as to extend the use of such devices while away from a direct source of power through the charge acquired by the internal battery of both the present technology and the individual electronics therein. Rechargeable batteries in phones and other portable personal electronics, such as Lithium-ion and Lithium-Polymer, NiCd, nickel-metal hydride (NiMH) batteries and Super Capacitors, can now be recharged via wireless power transmitting and receiving.

(2) Description of Related Art

Related art falls short in many regards. They fail to offer simultaneous, intelligent and automatic wireless charging for multiple devices. Many solutions that do exist do not offer true wire-free charging. Instead, users are still required to plug in their electronics devices in order to receive a charge. In addition, related art is very inadequate in terms of functionality and internal battery capacity. Lastly, related art offers little in terms of diversity when it comes to actually charging such devices.

### BRIEF SUMMARY OF THE INVENTION

The shortcomings of the prior art are overcome, and additional advantages are provided, through the provisions of the present technology. Provisions include multi-device wireless charging, including wireless charging through a stand or dock that provides consumers freedom from traditional power cords. The wireless charging described throughout may be inductive (based on the principles of magnetic inductance), resonant (based on the principles of magnetic resonance), and or uncoupled (a wire-free charging technology that supplies power to battery powered electronics over distance. The energy supply device includes multiple compartments to store electronic devices that are passively being charged by the large capacity battery sleeve. The large capacity battery sleeve is facilitated by the advances in flexible, thin, and greater density batteries. Depending upon the wireless source of power available, it may be advantageous for consumers to utilize the multiple means of aggregating power to maximize charging and versatility.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. A.0 illustrates an exemplary computing system.

FIG. A.1 illustrates an exemplary top view of one aspect of the present technology.

FIG. A.2 illustrates an exemplary top view of a second aspect of the present technology.

FIG. A.3 illustrates an exemplary top view of a third aspect of the present technology.

FIG. A.3.1 illustrates an exemplary top view of a Power Transferring Unit.

FIG. A.4 illustrates an exemplary top view of a fourth aspect of the present technology.

FIG. A.4.1 illustrates an exemplary top view of a Power Receiving Unit.

FIG. A.5 illustrates an exemplary top view of a fifth aspect of the present technology.

FIG. A.5a illustrates a second exemplary top view of the fifth aspect of the present technology in an additional configuration.

FIG. A.6 illustrates an exemplary top view of a sixth aspect of the present technology.

FIG. A.7 illustrates an exemplary top view of a seventh aspect of the present technology.

FIG. A.8 illustrates an exemplary top view of an eighth aspect of the present technology.

FIG. B illustrates an exemplary top view of aforementioned 8 aspect of the present technology together in one unified configuration.

FIG. C illustrates an exemplary side view of the present technology in one unified functional configuration.

### DETAILED DESCRIPTION OF INVENTION

While this technology is subject to embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, an and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Embodiments of the present disclosure are generally directed to an energy harvesting, multi-purpose sleeve that can acquire energy from multiple sources while at the same time automatically and simultaneously charging multiple electronic devices.

In various embodiments, the present technology charges multiple personal electronic devices (including but not limited to a laptop, tablet, cell phone, Bluetooth headset, smart watch, etc.) including itself while simultaneously acting as a stand or dock for the electronic devices. For example, the electronic devices are charged wirelessly and no cords are necessary. A recessed tray built into the stand portion (FIG. A.3) of the present technology along with the built-in wireless power transmitter behind the tray, allow the electronic devices to be conveniently used while they are being charged. In other words, the electronic devices do not have to lay flat on a charging pad or surface while they are being wirelessly charged. Thus, the electronic devices can be used and charged simultaneously. In some embodiments, the stand or dock portion of the present technology is equipped with a resonant repeater that extends the wireless charging range enough to enable wireless charging from a distance. For, example hand-held electronic devices or Bluetooth devices and the like could be charged through the air. Thus, offering consumers an even greater freedom from wired or even close proximity charging like a wireless charging tray.

The sleeve also includes multiple compartments to store the electronic devices that are capable of being passively charged wirelessly while in the sleeve. In some embodiments, the present technology also includes dock-able charging.

In some embodiments, the present technology is based upon the Airfuel Alliance (previously known as the Alliance for Wireless Power) standards which utilizes a technology known as magnetic resonance. Magnetic resonance enables high efficiency wireless energy transfer to electronic devices. The wireless charging may extend many millimeters so electronic devices stacked on top of one another can all be charged simultaneously. Thus, the wireless charging technology incorporated into the sleeve allows for electronic devices to be operated easily and securely while they are charging because they do not have to rest on a flat surface or directly contact an inductive charging transmitter. Other embodiments of the present technology may incorporate other wireless charging standards.

In various embodiments, the present technology is equipped with solar panels to charge the internal battery. The solar panels are designed to be replaceable so advances in solar panels can be incorporated into the sleeve. The present technology is equipped with convenient connectors so a user can add additional solar panels to harvest more energy using a photovoltaic system. Thus, the solar panels allow the user to use the present technology to recharge the internal battery anywhere the solar panels can be charged without the limitation of traditional sources of power.

In various embodiments, the internal battery of the present technology is replaceable so it can incorporate advances in battery technology. Thus, the sleeve allows for the internal battery to be upgraded or replaced as newer and better battery technology becomes available.

In various embodiments, the present technology is portable and can transform a backpack, purse, briefcase, or bag into an on-the-go, multi-device and effortless wireless charging accessory.

In some embodiments, the present technology includes built-in USB 3.1 ports for easy and fast charging of devices when a wireless transmitting unit (table, surface, or similar) is not available. In addition, the USB 3.1 technology supports charging of the battery sleeve from a traditional AC or DC (12-volt cigarette lighter socket provided in an automobile with voltage regulator and battery monitoring and charging circuits) power source as well as charging external electronic devices from the internal battery as needed.

In various embodiments, the present technology includes a GPS/Accelerometer/Sensors/Security and Bluetooth connectivity built into the sleeve. The built in sensors and communication features adds an alarm for finding the sleeve if it is lost or stolen. Furthermore, they enable proximity and movement detection which can be used to trigger an alarm or track the device with an application.

In some embodiments, the present technology allows for multiple means of accumulating power (AC, DC, wireless, and photovoltaic) and the high efficiency of magnetic resonance as well as the wireless charging technology built in enables the intelligent distribution of power via an application. The intelligent power management system allows for optimal and automatic charging of electronic devices as well as the present technology by aggregating and distributing one or more energy sources. The intelligent power management system identifies and controls power levels to ensure valid loads and thus protects non-compliant devices. For example, the sleeve aggregates power from solar, inductive charging, and/or direct wired connection and distributes the power to electronic devices or the battery of the sleeve as needed. Furthermore, the high efficiency of magnetic resonance wireless charging technology allows for additional aggregation and distribution.

FIG. A.0 illustrates an exemplary computing device 100 that may be used to implement an embodiment of the present systems and methods. The system 100 of FIG. A.1 may be implemented in the contexts of the likes of a server that includes processor 130 described herein. The computing system 100 of FIG. A.0 includes a processor 110 and main memory 120. Main memory 120 stores, in part, instructions and data for execution by processor 110. Main memory 120 may store the executable code when in operation. The computing system 100 of FIG. A.0 further includes mass storage devices 130, portable storage devices 140, output devices 150, user input devices 160, a display system 170, and peripherals 180.

The components shown in FIG. A.0 are depicted as being connected via a single bus 190. The components may be connected through one or more data transport means. Processor 110 and main memory 120 may be connected via a local microprocessor bus, and the mass storage devices 130, peripherals 180, portable storage device 140, and display system 170 may be connected via one or more input/output (I/O) buses.

Mass storage devices 130, which may be implemented with a magnetic disk drive or an optical disk drive, is a non-volatile storage device for storing data and instructions for use by processor 110. Mass storage devices 130 can store the system software for implementing embodiments of the present technology for purposes of loading that software into main memory 120.

Portable storage devices 140 operates in conjunction with a portable non-volatile storage medium, such as a floppy disk, compact disk or digital video disc, to input and output data and code to and from the computing system 100 of FIG. A.0. The system software for implementing embodiments of the present technology may be stored on such a portable medium and input to the computing system 100 via the portable storage devices 140.

Input devices 160 provide a portion of a user interface. Input devices 160 may include an alphanumeric keypad, such as a keyboard, for inputting alphanumeric and other information, or a pointing device, such as a mouse, a trackball, stylus, or cursor direction keys. Additionally, the computing system 100 as shown in FIG. A.0 includes output devices 150. Suitable output devices include speakers, printers, network interfaces, and monitors.

Display system 170 may include a liquid crystal display (LCD) or other suitable display device. Display system 170 receives textual and graphical information and processes the information for output to the display device.

Peripherals 180 may include any type of computer support device to add additional functionality to the computing system. Peripherals 180 may include a modem, router, wireless adapter, Wi-Fi or cellular antennas via convenient connectors.

The components contained in the computing system 100 of FIG. A.0 are those typically found in computing systems that may be suitable for use with embodiments of the present technology and are intended to represent a broad category of such computer components that are well known in the art. Thus, the computing system 100 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description but is not intended to be exhaustive or limited to the technology in the form disclosed. Many modifications and variations will be apparent to those of ordinary skill in the art without departing from the scope and spirit of the technology. Exemplary embodiments were chosen and described in order to best explain the principles of the present technology and its practical application, and to enable others of ordinary skill in the art to understand the technology for various embodiments with various modifications as are suited to the particular use contemplated.

Aspects of the present technology are described above with reference to flowchart illustrations and/or block diagrams of methods, apparatus (systems) and computer program products according to embodiments of the technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data-processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the present technology has been described in connection with a series of preferred embodiments, these descriptions are not intended to limit the scope of the technology to the particular forms set forth herein. It will be further understood that the methods of the technology are not necessarily limited to the discrete steps or the order of the steps described. To the contrary, the present descriptions are intended to cover such alternatives, modifications, and equivalents as may be included within the spirit and scope of the technology as defined by the appended claims and otherwise appreciated by one of ordinary skill in the art.

1. A device comprising of an intelligent wireless charging system for automatic and simultaneous charging of multiple electronic devices;
a. said device possessing a processor programmed to aggregate power from the wired charging port, the internal battery, the solar panel, and the wireless power transmitting unit(s), and intelligently detect charging protocols and distribute the power to one or more devices;
b. said device possessing a wireless power transmitting unit(s);
c. said device compatible with charging protocols and standards set by chip makers such as, but not limited to, those in the Airfuel Alliance;
d. said device enables charging while certain electronics products are in use;
e. said device possesses capability of charging even larger electronics such as a laptop that demand greater energy;
f. said device containing a plurality of storage compartments automatically charging one or electronic devices.

2. (canceled)

3. A device that aggregates and stores energy from multiple sources;
a. said device may aggregate and store energy from AC line, DC input, wired charging port(s), such as USB 3.1 Thunderbolt, solar, piezo, capacitive, or inductively coupled sources;
b. said device containing a large capacity internal battery;
c. said device where in some embodiments the internal battery is replaceable;
d. said device containing solar panel capable of harvesting energy(s);
e. said device containing a wireless power receiving unit(s).

4. (canceled)

5. (canceled)

6. (canceled)

7. (canceled)

8. (canceled)

9. (canceled)

10. (canceled)

11. (canceled)

12. (canceled)

13. A multi-functional device capable of securing, organizing, charging, storing, and docking electronic devices;
a. said device in that incorporates security features such as an accelerometer, Bluetooth, GPS, and/or proximity sensors that connect to an application;
b. said device contains a plurality of storage compartments capable of storing, organizing, carrying, charging, and docking multiple electronic devices;
c. said device functions as a stand for electronic devices.

14. (canceled)

15. (canceled)
